(19) United States
(12) Patent Application Publication
(10) Pub. No.: US 2015/0134250 A1
(43) Pub. Date: May 14, 2015

(54) METHOD OF ANALYSIS OF ELECTRON DENSITY OF IONOSPHERE

(71) Applicant: Electronics and Telecommunications Research Institute, Daejeon (KR)

(72) Inventor: Yong-Min LEE, Daejeon (KR)

(21) Appl. No.: 14/307,974

(22) Filed: Jun. 18, 2014

(30) Foreign Application Priority Data
Nov. 13, 2013 (KR) 10-2013-0137921

(51) Int. Cl. G01W 1/16; G01S 13/02

(52) U.S. Cl. CPC G01W 1/16; G01S 13/02
USPC 702/3

(57) ABSTRACT

A method for an ionosonde to analyze the electron density of the ionosphere includes: receiving oblique sounding data in an oblique direction, rather than vertically above the ionosonde in the sky; converting the oblique sounding data into vertical sounding data; calculating the amplitude array based on the vertical sounding data; and analyzing the electron density of the ionosphere in the sky at an intermediate location based on the oblique sounding data and the converted vertical sounding data.

### CROSS-REFERENCE TO RELATED APPLICATION

This application claims priority to and the benefit of Korean Patent Application No. 10-2013-0137921 filed in the Korean Intellectual Property Office on Nov. 13, 2013, the entire contents of which are incorporated herein by reference.

### BACKGROUND OF THE INVENTION

(a) Field of the Invention

The present invention relates to a method of analysis of the electron density of the ionosphere.

(b) Description of the Related Art

In a communication system for long-distance communications, radio reflection from the ionosphere can be used. Accordingly, when the ionosphere is disturbed due to solar activity, high frequency (HF) signals are distributed, leading to a disturbance in long-distance communication. Also, when the electron density of the ionosphere changes abruptly due to solar activity, a short-period fluctuation in radio waves occurs, and this may cause interference in global positioning system (GPS) signals or satellite communication signals (UHF and VHF bands). Moreover, if aircraft or the like lies in a straight line with the sun, the radio wave frequency for aircraft control may not work due to a solar radio burst.

A magnetic storm caused by a solar flare brings an abrupt change in the environment surrounding the Earth. Hereupon, ionosphere disturbance causes unnecessary abruption or reflection, resulting in anomalous radio wave propagation. Further, changing the electron density of the ionosphere affects GPS signals, and can cause position errors of several meters to several kilometers. Particularly, since modern society is rapidly changing into a smart information communication environment, the effect of cosmic radio waves generated by solar activity is becoming stronger. For example, cosmic radio waves cause changes in the Earth's ionosphere and severely affect the information communication environment based on the ground and space infrastructure. Accordingly, the technology of analysis of the electron density of the ionosphere caused by solar activity is emerging as the core technology for building a constant monitoring system of cosmic radio wave disturbance.

Conventionally, a method of observing the ionosphere in the sky vertically above ionosondes distributed at a number of locations on the ground is used for ionosphere observation. Accordingly, changes in the ionosphere between two locations where ionosondes are located cannot be observed. Thus, it is difficult to determine the cause of an abrupt disturbance in radio communication when long distance communication takes place between two locations. In order to observe changes in the ionosphere in a plurality of locations, it is necessary to install more ionosondes, and this leads to budgetary and site acquisition problems.

### SUMMARY OF THE INVENTION

The present invention has been made in an effort to provide a method of observing the ionosphere between two locations by using ionosondes installed at two locations.

An exemplary embodiment of the present invention provides a method for an ionosonde to analyze the electron density of the ionosphere at an intermediate location where no ionosonde is located. The method of analyzing electron density includes: receiving oblique sounding data in an oblique direction, rather than vertically above an ionosonde in the sky; converting the oblique sounding data into vertical sounding data; calculating an amplitude array based on the vertical sounding data; and analyzing the electron density of the ionosphere in the sky at an intermediate location based on the oblique sounding data and the converted vertical sounding data.

In the method of electron density analysis, the oblique sounding data may be sounding data that is radiated from another ionosonde, reflected from the sky at the intermediate location, and incident in a direction oblique to the ionosonde.

In the method of electron density analysis, the converting may include removing noise or interference signals from the oblique sounding data.

In the method of electron density analysis, the converting may further include extracting the trace of the oblique sounding data from which noise or interference signals are removed, and converting the trace into vertical sounding data.

In the method of electron density analysis, the converting of the trace into vertical sounding data may include doing so while taking into account incidence and arrival angles of the oblique sounding data, a distance between the location of the ionosonde and the location of the other ionosonde, and obliquely sounding frequency.

In the method of electron density analysis, the calculating of the amplitude array may include extracting a plurality of parameters from the vertical sounding data, and calculating the amplitude array by using the plurality of parameters.

In the method of electron density analysis, the extracting of a plurality of parameters may include determining if parameters can be extracted from the vertical sounding data, and if not, repeating the conversion and the extraction a predetermined number of times.

In the method of electron density analysis, the analyzing of the electron density may include calculating the true height of the ionosphere at the intermediate location based on the amplitude array, and analyzing the electron density of the ionosphere at the intermediate location based on the true height.

In the method of electron density analysis, the analyzing of the electron density of the ionosphere at the intermediate location based on the true height may include: comparing the true height and virtual height of the ionosphere; if the true height is greater than the virtual height, determining that the analyzed electron density is not valid and re-calculating the amplitude array; and if the true height is less than or equal to the virtual height, outputting the result of electron density analysis.

According to an embodiment of the present invention, the ionosphere between two locations geographically spaced apart from each other, can be observed by using ionosondes located at the two locations. As the ionosphere between the two locations can be observed by using conventional vertical incidence ionosondes, such effects as communication failures, increase of GPS position errors, etc., and the electron density of the ionosphere disturbed by solar activity has on communication infrastructures, can be effectively analyzed. Moreover, a forecasting and warning system for the space environment can be built with efficiency.

### BRIEF DESCRIPTION OF THE DRAWINGS

FIG. 1 is a view showing an ionosphere observation system for observing the ionosphere between two adjacent regions according to an exemplary embodiment of the present invention.

FIG. 2 is a flowchart showing a method of analysis of the electron density of the ionosphere according to an exemplary embodiment of the present invention.

FIG. 3 is a graph showing electron density profiles output from an ionosonde according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Parts irrelevant to the description are omitted to clearly describe the present invention, and like reference numerals denote like elements throughout the drawings.

In the specification, when a certain part “includes” a certain component, this indicates that the part may further include another component instead of excluding another component unless there is no different disclosure. In addition, terms such as “. . . unit,” “ . . . er/or,” “module,” or “block” disclosed in the specification indicates a unit for processing at least one function or operation, and this may be implemented by hardware, software, or a combination of both.

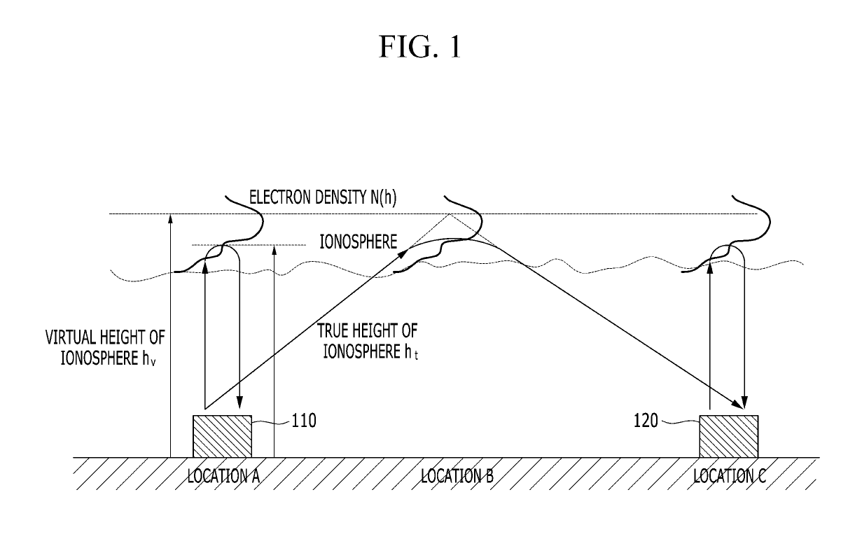

FIG. 1 is a view showing an ionosphere observation system for observing the ionosphere between two adjacent regions according to an exemplary embodiment of the present invention.

Referring to FIG. 1, an ionosonde located at location A and an ionosonde located at location B can observe the ionosphere in the sky above location C located between location A and location B. That is, a plurality of ionosondes can radiate sounding signals in an oblique direction, as well as vertically above the ionosondes in the sky, and other ionosondes can detect the radiated sounding signal. Thus, even the ionosphere in such locations as location C where no ionosonde is located can be observed.

A method of observing the ionosphere in the sky at a location with no ionosonde between two locations by using ionosondes located at the two locations will be described below.

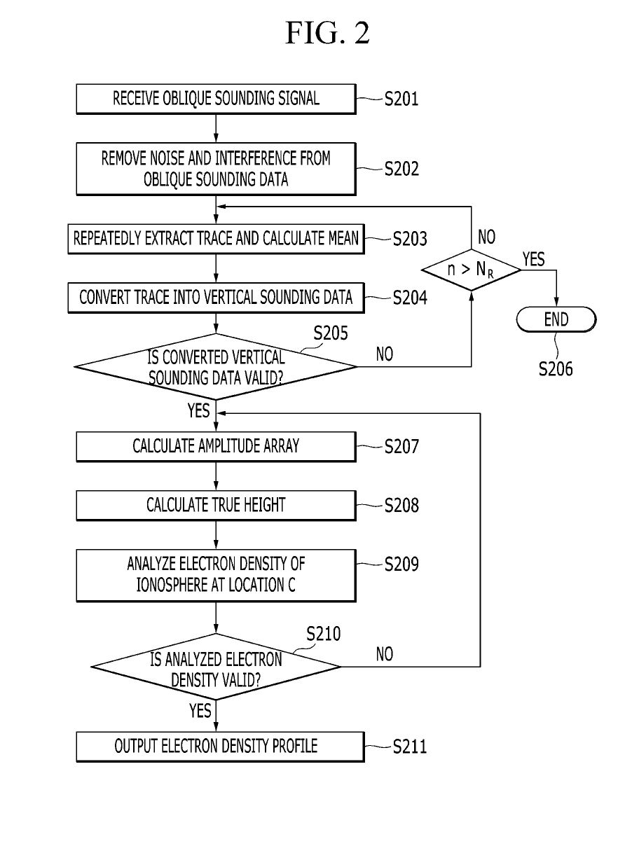

FIG. 2 is a flowchart showing a method of analysis of the electron density of the ionosphere according to an exemplary embodiment of the present invention.

First, a first ionosonde located at location A radiates sounding signals toward the ionosphere. The first ionosonde radiates a sounding signal (vertical sounding signal) vertically above the location of the first ionosonde in the sky, and also radiates a sounding signal (oblique sounding signal) in an oblique direction across the sky.

Thereafter, a sounding signal radiated by the first ionosonde is reflected and reaches the other ionosonde (S201). In the present invention, it is assumed that the second ionosonde located at location B receives the sounding signal radiated by the second ionosonde. The sounding signal reflected at the ionosphere is directed in a direction that is non-vertical and oblique to the second ionosonde, and the signal that reaches the second ionosonde is referred to as oblique sounding data.

The second ionosonde then removes noise or interference signals from the oblique sounding data (S202). Next, it extracts the time delay value of the oblique sounding data depending on changes in the frequency of the oblique sounding signal and extracts the trace of the oblique sounding data (S203). The trace is tracked data obtained by applying an algorithm to the oblique sounding data. The trace may not be accurate depending on many factors such as observation time, observation environment, solar activity, etc. Thus, the trace is repeatedly tracked to calculate the mean.

The trace of the oblique sounding data is then converted into vertical sounding data (S204). In this case, the second ionosonde converts the trace of the oblique sounding data into vertical sounding data, taking into account the incidence angle of the oblique sounding signal from location A (i.e., the angle of radiation of a sounding signal from location A), the arrival angle of the oblique sounding signal (the angle of arrival of a reflected sounding signal at location B), the distance between the two locations, obliquely sounding frequency, and so on.

Thereafter, the second ionosonde determines if the converted vertical sounding data is valid (S205). That is, the second ionosonde determines if it can extract primary parameters such as foF1, foF2, etc., required to calculate the electron density of the ionosphere from the converted vertical sounding data. If it can extract primary parameters from the converted vertical sounding data, the steps S203 and S204 are repeated a predetermined number of times N_{R}. If primary parameters are not extracted even after repeating the steps S203 and S204 a predetermined number of times (n>N_{R}), it is determined that analysis cannot be done, and the analysis process is terminated (S206).

However, if the second ionosonde has extracted primary parameters such as foF1 and foF2, and maximum usable frequency (MUF), the second ionosonde calculates the amplitude array A (fᵢ, h′ᵢ) by using the extracted primary parameters (S207). The second ionosonde then calculates the true height hₜ of the ionosphere (located vertically above location C in the sky) based on the amplitude array (S208). Further, the second ionosonde analyzes the electron density of the ionosphere between the two locations where the first and second ionosondes are located, based on the true height of the ionosphere (S209). For example, the second ionosonde analyzes the electron density of an E layer, an F1 layer, and an F2 layer and changes in the electron density of the boundary between these layers.

In this case, the second ionosonde compares the virtual height hᵥ and true height hₜ of the ionosphere at each frequency to determine if the analyzed electron density at location C is valid (S210). As used herein, the virtual height is an observation value obtained by the first and second ionosondes. If the true height is greater than the virtual height, it is determined that the result of electron density analysis is not valid, and the process returns to the step of calculating the amplitude array from the converted vertical sounding data.

On the other hand, if it is determined that the result of electron density analysis is valid because the true height is no greater than the virtual height, the electron density profile depending on changes in plasma frequency is output (S211).

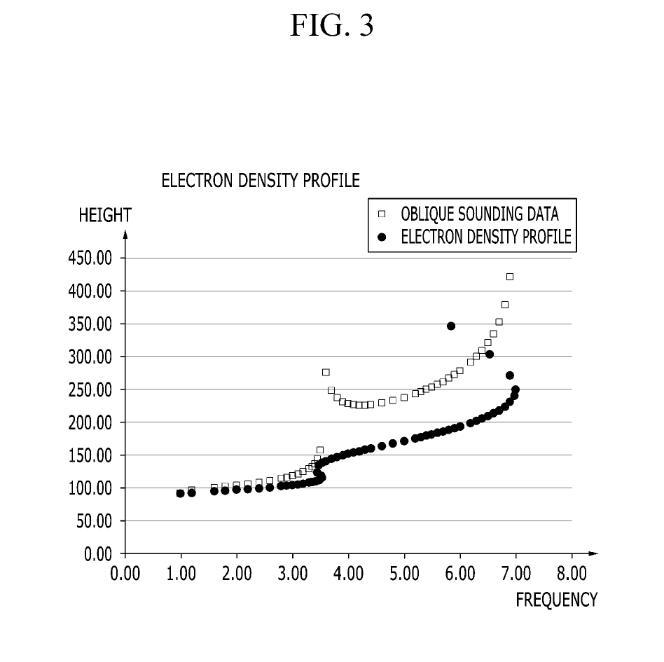

FIG. 3 is a graph showing electron density profiles output from an ionosonde according to an exemplary embodiment of the present invention.

The x-axis denotes the plasma frequency or critical frequency, and the y-axis denotes the true height. The curve indicated by □ in FIG. 3 represents oblique sounding data, and the curve indicated by in FIG. 3 represents electron density profiles. Referring to FIG. 3, it is found that the electron density between location A and location B can be effectively calculated based on oblique sounding data.

According to a method of analysis of the electron density of the ionosphere according to an exemplary embodiment of the present invention, the ionosphere between two locations, geographically spaced apart from each other, can be observed by using ionosondes located at the two locations. As the ionosphere between the two locations can be observed by using conventional vertical incidence ionosondes, such effects as communication failures, increase of GPS position errors, etc., the electron density of the ionosphere disturbed by solar activity has on communication infrastructures can be effectively analyzed. Moreover, a forecasting and warning system for the space environment can be built with efficiency.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for an ionosonde to analyze electron density of the ionosphere at an intermediate location where no ionosonde is located, the method comprising:
receiving oblique sounding data in an oblique direction, rather than vertically above an ionosonde in the sky;
converting the oblique sounding data into vertical sounding data;
calculating an amplitude array based on the vertical sounding data; and
analyzing the electron density of the ionosphere in the sky at an intermediate location based on the amplitude array, the oblique sounding data and the converted vertical sounding data.

2. The method of claim 1, wherein the oblique sounding data is sounding data of sounding signal, wherein the sounding signal is radiated from another ionosonde, reflected from the sky at the intermediate location, and incident in a direction oblique to the ionosonde.

3. The method of claim 2, wherein the converting comprises removing noise or interference signals from the oblique sounding data.

4. The method of claim 3, wherein
the converting further comprises:
extracting trace of the oblique sounding data from which noise or interference signals are removed; and
converting the trace into vertical sounding data.

5. The method of claim 4, wherein the converting of the trace into vertical sounding data comprises doing so while taking into account incidence and arrival angles of the oblique sounding data, a distance between the location of the ionosonde and the location of the other ionosonde, and obliquely sounding frequency.

6. The method of claim 1, wherein
the calculating of the amplitude array comprises:
extracting a plurality of parameters from the vertical sounding data; and
calculating the amplitude array by using the plurality of parameters.

7. The method of claim 6, wherein
the extracting of a plurality of parameters comprises:
determining if parameters can be extracted from the vertical sounding data; and
if not, repeating the conversion and the extraction a predetermined number of times.

8. The method of claim 1, wherein
the analyzing of the electron density comprises:
calculating true height of the ionosphere at the intermediate location based on the amplitude array; and
analyzing electron density of the ionosphere at the intermediate location based on the true height.

9. The method of claim 8, wherein
the analyzing of the electron density of the ionosphere at the intermediate location based on the true height comprises:
comparing the true height and virtual height of the ionosphere;
if the true height is greater than the virtual height, determining that the analyzed electron density is not valid and re-calculating the amplitude array; and
if the true height is less than or equal to the virtual height, outputting the result of electron density analysis.
